(19) United States
(12) Patent Application Publication
(10) Pub. No.: US 2026/0316654 A1
(43) Pub. Date: Oct. 15, 2026

(54) FLATBED FOR SIMULTANEOUSLY HANDLING PLURAL PALLETS

(71) Applicant: Government of the United States as represented by the Secretary of the Air Force, Wright-Patterson AFB, OH (US)

(72) Inventors: John Tippetts, Austin, TX (US); Michael Sturtevant, Yigo, GU (US); Michael Morgan, Chandler, AZ (US)

(21) Appl. No.: 19/179,520

(22) Filed: Apr. 15, 2025

(51) Int. Cl. B60P 1/43; B60P 1/04; B60S 9/02

(52) U.S. Cl. CPC B60P 1/433; B60P 1/04; B60S 9/02

(57) ABSTRACT

An elongate flatbed for transporting pallets in austere environments. The flatbed has at least two independently operable winches for simultaneously loading and/or unloading at least two pallets of equipment, supplies and other cargo onto or offloaded from a low friction deck of the flatbed. Each winch has a cable which is independently and removably attachable to a designated pallet. The cables of the winches have independent and separate cable paths to prevent interference with the other cable. One cable path is routed underneath the deck of the flatbed for separation from the other cable path.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a flatbed having a deck for receiving pallets of cargo and transporting the pallets to offload points of use, more particularly to such a flatbed having plural winches for simultaneous loading and unloading of pallets and more particularly to such a flatbed having at least one winch with an undermounted winch cable.

### BACKGROUND OF THE INVENTION

For generations combat offload procedures have been designed to move supplies and equipment from a cargo aircraft into an austere or hostile location. These locations are often under development or otherwise lack the infrastructure to move pallets of supplies and equipment from the aircraft offload point to a viable point of use. Loads of supplies, equipment and other cargo on a rigid support surface (collectively referred to as pallets) are often delivered to the hostile location by cargo aircraft such as a Boeing C-17 or CH-47 or a Lockheed Martin C-130, C-27, C-9 or C-5. Pallets are the most common form of delivery due to the specified and uniform size regimenting handling and training. It is to be understood that ‘pallets’ as used herein includes 463L (HCU6/E) pallets, other types of pallets and other unitary bundles of equipment, supplies and cargo.

Offload must move quickly and efficiently in a combat environment. Cargo aircraft must be promptly removed from the hostile environment and returned to service. Pallets which are left on the ground are subject to sabotage or other hostile acts. By the ground it is meant to include dirt/grass/gravel surfaces, runways, tarmacs, hangar floors, or any support surface for the pallet. Furthermore, supplies, cargo and equipment which are needed for combat operations cannot be deployed unless the respective pallets are rapidly transported to the point(s) of use.

The pallets are traditionally offloaded from the aircraft onto the runway by a forklift. The aircraft quickly departs to minimize vulnerability and continue the mission. Three combat offload methods are approved for use by the Air Force.

Combat Method A occurs by unlocking the pallets of interest, lowering the back ramp of a plane, such as a C-17, revving the engines and releasing the brakes. The sudden forward lurch of the plane leaves the pallet(s) behind due to the lack of momentum relative velocity of the aircraft. Combat Method A is suitable for total pallet weights of 1000 lbs. to 12000 lbs. and not containing fragile items.

Combat Offload Method B applies to any item not exceeding 1500 lbs. For this method, eight barrels are lined up with four on each side parallel to the back ramp of an aircraft such as a C-130. The pallets are chained to the tailgate of a truck which will help pull the cargo off the C-130 as it slowly taxis forward. As the cargo is removed, airmen slide barrels underneath the corners of the pallet. This process continues until all desired equipment is removed from the aircraft. This process must be synchronized, demanding constant communication from the loadmasters, driver and aircrew. And the aircraft's engines must remain running in order for the pilots to slowly taxi and release the equipment.

Combat Method C enables controlled offload of single or multiple pallets with minimal ramp/taxiway space, when no external equipment or support is available, the pallets have a high CoG or the cargo is fragile. In Combat Method C offloaded pallets are disposed on a lowered cargo ramp of the aircraft, controlling the descent speed using a winch, or draft strap, allowing gravity to carry each pallet until it clears the ground loading ramps 30 and is on the runway.

A requirement common to each of Combat Methods A, B and C is to move the pallets from the offload point on the runway to a point of use. The point of use can be a site for unpacking, for further distribution and/or immediate consumption. A forklift has long been used to shuttle pallets from the offload point to these locations where the pallets will ultimately be used.

But the forklift displaces 5 pallet positions on the cargo aircraft and a supporting pallet of tools and fuel can displace a sixth pallet position. Up to six pallets of supplies and equipment are sacrificed. And attendant costs, personnel time and safety considerations are necessary to put the forklift into operation. Particularly, once the forklift arrives at the hostile site 95 manhours are required for assembly and qualification of the forklift. Only then can the pallets be maneuvered to new locations for use.

Accordingly, it is an object of this invention to overcome the problem of requiring plural pallet positions on a cargo aircraft for a single forklift which has only the limited and dedicated functionality of removing pallets from an offload position or for a single K-loader. It is further an object of this invention to provide for offloading equipment, supplies and other cargo without the intermediate step of loading a pallet onto static barrels, then offloading the pallets from the barrels for ultimate transport to the point of use.

It is particularly an object of this invention to provide a flatbed for simultaneously loading and unloading plural pallets onto and off of a transport vehicle and more particularly to provide such a flatbed having independently operable means for simultaneously loading and unloading pallets.

### SUMMARY OF THE INVENTION

In one embodiment the invention comprises a flatbed for receiving and discharging plural pallets. The flatbed has mutually perpendicular longitudinal, transverse and vertical axes. The flatbed comprises a deck having a downwardly facing surface and a low friction upwardly facing surface opposed thereto, the deck having first and second longitudinally opposed ends, and a first plurality of spaced apart winches connected to the downwardly facing surface, each winch of the first plurality of winches having a retractable and extendible cable operably associated therewith, whereby each cable is extendable from the corresponding winch below the flatbed to a respective port through the flatbed, upwards through the port and longitudinally above the flatbed to an edge of the flatbed for releasably attaching the cable to respective cargo.

In one embodiment the invention comprises a flatbed for loading, conveying and offloading plural pallets. The flatbed has a longitudinal axis and a transverse axis orthogonal thereto. The flatbed comprises a deck having a downwardly facing surface and a low friction upwardly facing surface opposed thereto, the deck having a front end and rear end longitudinally opposed thereto, a first winch connected to the downwardly facing surface, the first winch having a retractable and extendible first cable operably associated therewith a port through the flatbed whereby the first cable is extendible through the port to be removably attachable to a first pallet disposed on the upwardly facing surface and a second winch forward of the first winch and juxtaposed with the upwardly facing surface, the second winch having a retractable and extendible second cable operably associated therewith and being removably attached to a second pallet disposed on the upwardly facing surface.

In one embodiment the invention comprises a flatbed for simultaneous loading of plural pallets thereon, transporting the pallets to a point of use and simultaneous unloading of plural pallets therefrom. The flatbed has a longitudinal axis and a transverse axis orthogonal thereto and comprises a deck having a downwardly facing surface and a low friction upwardly facing surface opposed thereto, the deck having a front end and rear end longitudinally opposed thereto, a first winch connected to the downwardly facing surface, the first winch having a retractable and extendible first cable operably associated therewith a port through the flatbed whereby the first cable is extendible through the port to be removably attachable to a first pallet disposed on the upwardly facing surface, and a second winch forward of the first winch and juxtaposed with the upwardly facing surface, the second winch having a retractable and extendible second cable operably associated therewith and being removably attached to a second pallet disposed on the upwardly facing surface.

### BRIEF DESCRIPTION OF THE DRAWINGS

All figures, and portions thereof, listed as scale views are drawn to scale. All figures, and portions thereof, listed as schematic are not drawn to scale. In some figures having pallets, the pallets are shown for clarity as being two dimensional, it being understood the pallets will have height in the vertical direction.

FIG. 1A is a scale bottom perspective view of a flatbed according to the present invention.

FIG. 1B1 is a scale top perspective view of the flatbed of FIG. 1A having a schematic controller and schematic driver.

FIG. 1B2 is a scale enlarged fragmentary perspective view of the flatbed of FIG. 1B1.

FIG. 1C is a scale top plan view of the flatbed of FIG. 1A.

FIG. 1D is a schematic profile sectional view of a deck according to the present embodiment having indeterminate length and alternative ports for an offset winch.

FIG. 1E is a schematic top plan view of an alternative embodiment of a deck having offset winches.

FIG. 1E is a schematic vertical sectional view taken along line E E of FIG. 1D.

FIG. 2A is a scale perspective view of a flatbed according to the present invention having a forward winch mounted above the deck and a schematic tractor.

FIG. 2B is a scale perspective view of the flatbed of FIG. 2A having the jacks deployed.

FIG. 2C is a scale partially fragmentary perspective view of the flatbed of FIG. 2A having the ramps deployed.

FIG. 2D is a scale side elevational view of the flatbed of FIG. 2C.

FIG. 2E is a scale top plan view of the flatbed of FIG. 2C.

FIG. 2F is a schematic side elevational view of an alternative embodiment of a straight axle stepped deck flatbed with a door shown in cutaway.

FIG. 3A is a scale side elevational view of the flatbed of an alterative embodiment having an elevatable deck.

FIG. 3B is a scale perspective view of the flatbed of FIG. 3A having plural extended ramps.

FIG. 4A is a schematic top plan view of an alternative embodiment of a deck having mutually opposed winches.

FIG. 4B is a schematic vertical sectional view taken along line B B of FIG. 4A.

FIG. 4C is a schematic side elevational view of an optional crowned embodiment of a flatbed of the deck of FIG. 4A.

FIG. 5 is a scale fragmentary top plan view of a cargo load in an aircraft comparing the footprint of the present invention to the prior art.

### DETAILED DESCRIPTION OF THE INVENTION

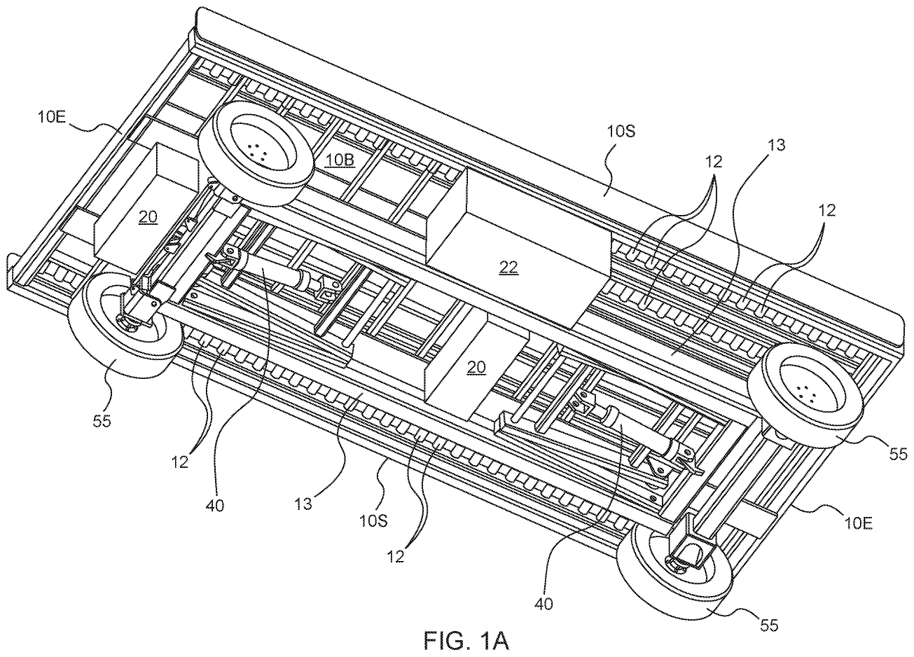

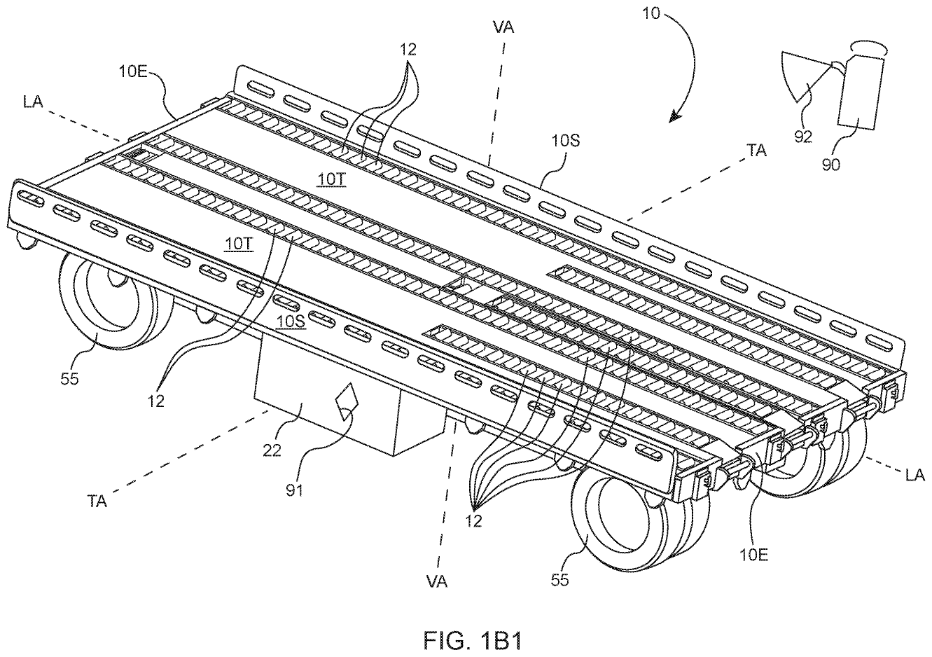

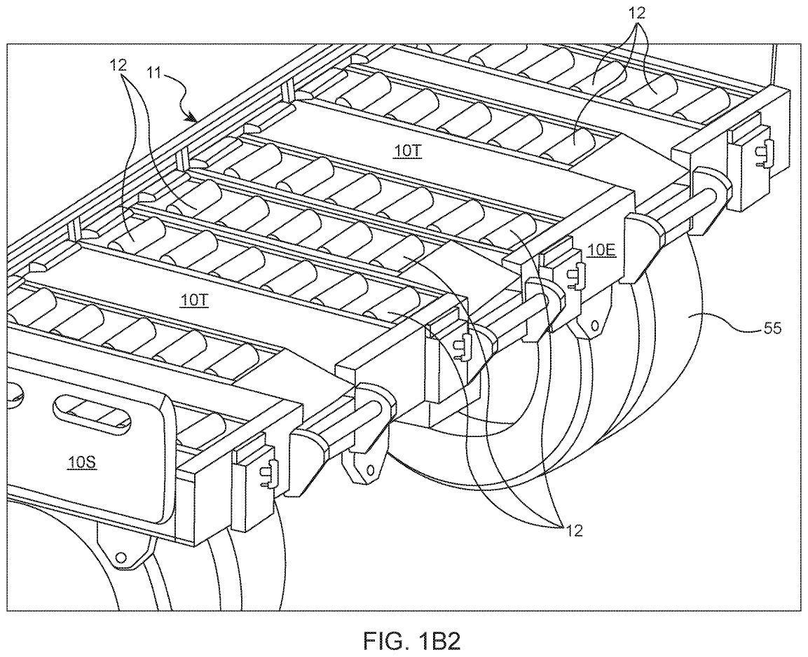

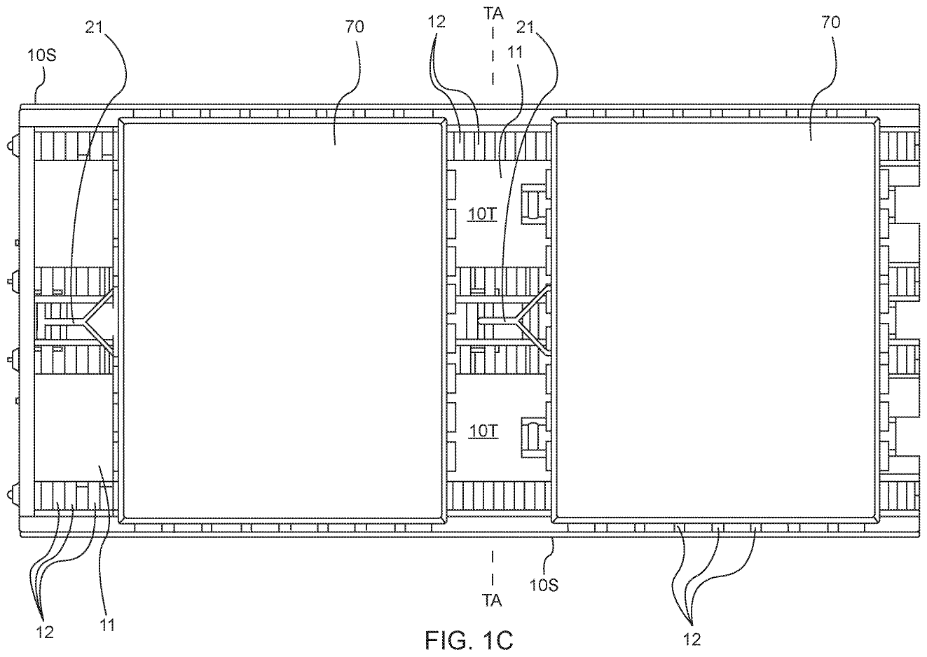

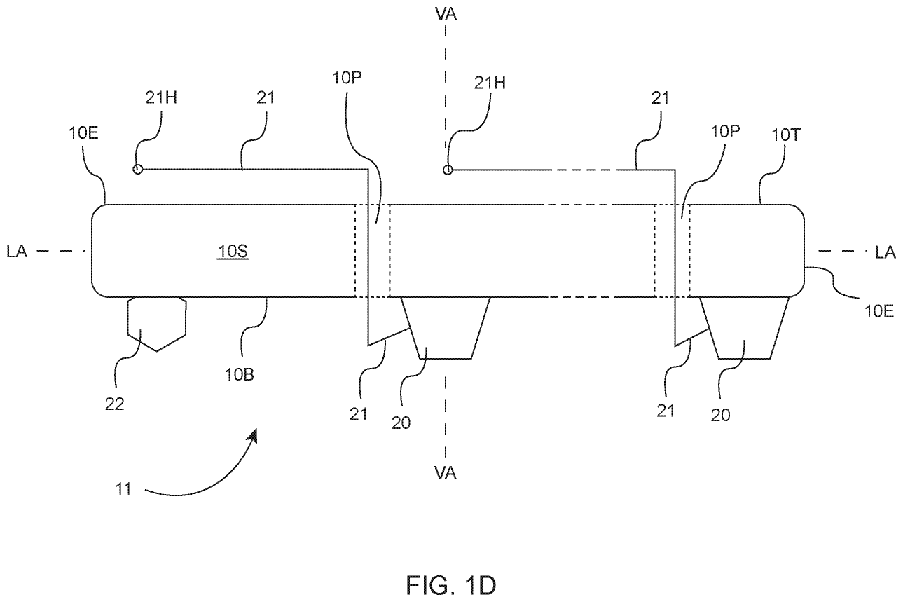

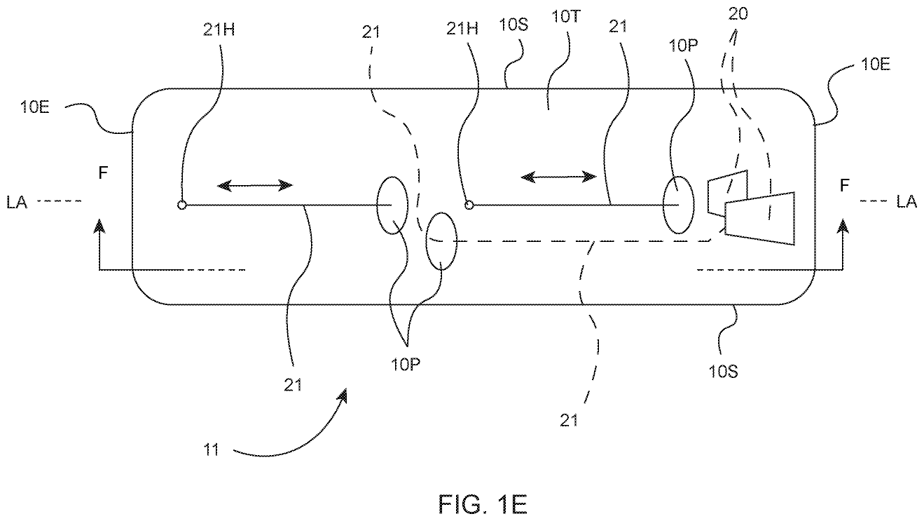

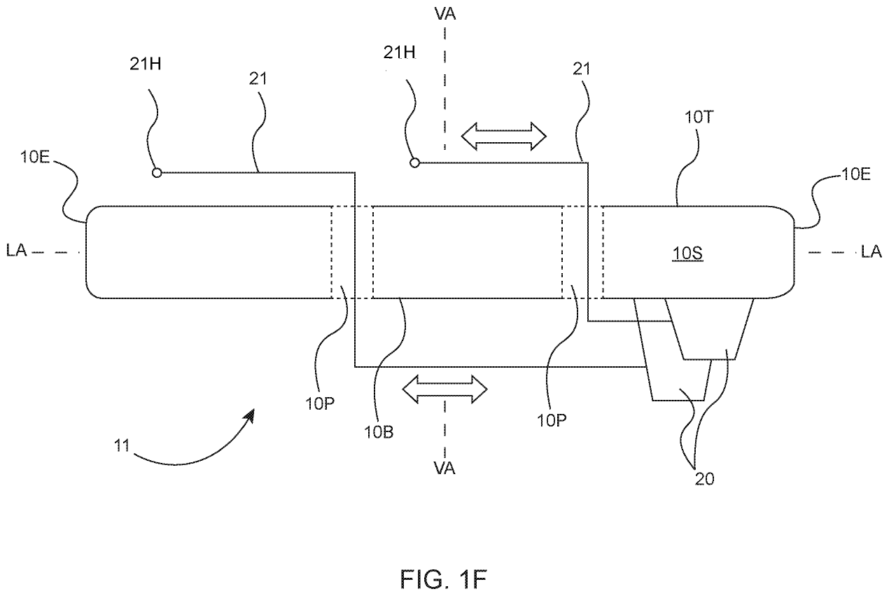

Referring to FIGS. 1A-1D, the invention comprises a flatbed 10. The flatbed 10 is a vehicle having plural wheels 55 connected by a frame 13 supporting a deck 11 suitable for loading pallets thereon for transport and unloading the pallets at a point of use. The flatbed 10 has plural winches 20 for simultaneous manipulation of plural pallets. Functionally, the flatbed 10 has at least two independently operable means for simultaneously loading and/or unloading at least two pallets.

This vehicle is suitable for transporting one or more pallets from an offload point directly to a point of use without having to intermediately dispose any pallet 70 on the ground. The flatbed 10 has an engine 54, wheels 55, steering, optional transmission, optional accommodation for a driver 90/passenger, at least one loading/unloading ramp 30 and other common vehicular hardware. The flatbed 10 may be executed as a trailer 50 releasably hitchable to a tractor 61, as a straight axle vehicle, as a boat, etc. The flatbed 10 may be driven by a driver 90 thereon or by a driver 90 using wired/wireless remote control to/from a transceiver 92/controller 91 on the flatbed 10.

More particularly, the pallets 70 under consideration may be directly offloaded from an aircraft onto the flatbed 10, transported by that flatbed 10 to a remote location and then unloaded at one or more points of use to distribute the pallets 70 as desired. Furthermore, the pallets 70 may be directly loaded onto the flatbed 10, transported to one or more points of use, then unladed at the one or more points of use without additional equipment or support vehicles.

The winches 20, ramps 30 and/or locomotion of the flatbed 10 may be provided by a single engine 54 or the winches 20 may be provided by a separate engine 54. Alternatively, each winch 20 may have a dedicated hydraulic power unit 22 (HPU 22) or by a single HPU 22. The HPU 22 includes a motor, valves, fluid reservoir and pump. The HPU 22 pressurizes hydraulic fluid, such as oil, to actuate the jacks 40, decks 11, winch and other components as may be helpful.

By manipulation it is meant both loading and unloading of plural pallets 70. Plural winches 20 may be used with a single pallet 70 as needed to accommodate the load or a single winch 20 may be used with plural pallets 70 if the combined weight of the plural pallets 70 does not exceed the capacity of the winch.

Examining the invention in more detail, the deck 11 may be generally planar having a downwardly facing surface 10B oriented towards the ground and a low friction upwardly facing 10T surface opposed thereto. The deck 11 defines a longitudinal axis LA of the flatbed 10 with longitudinally spaced apart ends 10E for loading and unloading. A transverse axis TA is perpendicular to the longitudinal axis LA and lies within the plane of the deck 11 with transversely spaced apart sides 10S configured to prevent unintended loss of pallets 70 from the sides 10S of the deck 11. A vertical axis VA is perpendicular to the longitudinal axis LA and the transverse direction TD.

The low friction upwardly facing surface 10T receives pallets 70 thereon and delivers pallets 70 therefrom, both in substantially the longitudinal direction. The deck 11 may have optional guard rails to prevent unintended movement in the transverse direction TD or spillage of a pallet. The upwardly facing surface 10T may comprise a static smooth plane to prevent undue friction and minimize the energy necessary to bilaterally longitudinally move pallets 70 thereon. This smooth surface 10T may comprise a hard, low friction plate such as Nylon, PTFE, UHMW, PET-P, etc. Alternatively, the low friction surface 10T may be dynamic and comprise longitudinally oriented endless belts. The belts may be motor driven or actuated by movement of the pallet 70 thereon. Preferably, the low friction surface 10T comprises at least one row of axially rotatable rollers 12. The rollers 12 of a single row may extend substantially transversely across the deck 11 or may be transversely spaced apart in plural rows as shown. The rollers 12 may define the upwardly facing surface 10T and be made of nylon, hardened steel, etc., and have axes parallel to the transverse direction. The rollers 12 are preferably not driven, but rotate responsive to tangential sliding of the pallets 70 across the upwardly facing surface 10T defined by the upper edges of the rollers 12. Optionally the deck 11 may have forklift clearance channels, as disclosed in commonly assigned U.S. Pat. No. 12,258,146 issued Mar. 25, 2025 to Kurtz et al. and incorporated herein by reference in its entirety.

The flatbed 10 has at least one ramp which provides a path for conveying pallets 70 to and from the ground or other support surface onto and off of the deck 11. More particularly each ramp has a proximal end which connects to the flatbed 10 and optionally more particularly to the deck 11 thereof. The ramp has a distal end longitudinally remote from the proximal end and which intercepts the ground for use when loading and unloading pallets 70. Optionally the flatbed 10 may have plural transversely spaced ramps 30 to safely accommodate the expected loads. The ramps 30 are preferably manually actuated or may be operated under power. Operation of the ramps 30 alternatingly retracts the ramps 30 into a transport position within the deck 11 for safe movement of the flatbed 10 and protrudes the ramps 30 outwardly from the deck 11 to a loading/offloading position for receiving and disbursing pallets 70 while the flatbed 10 is preferably stationary.

Plural ramps 30 may move in parallel to save time in the loading and unloading process. Alternatively, one or more ramps 30 may remain retracted into a tunnel 31 within the deck 11 when not needed for a particular pallet 70 load.

The ramp may be retracted into juxtaposition with the deck 11 of the flatbed 10 when not in use and to accommodate transport of the flatbed 10 between sites and storage. The ramp is longitudinally protruded outwardly from the deck 11 and angled for the distal end to intercept the ground at a suitable location away from the flatbed 10 where a predetermined pallet 70 may be temporarily disposed.

The flatbed 10 has plural winches 20. At least one of the winches 20 is mounted underneath the deck 11. Each winch 20 has an associated cable 21 with a hook, clevis, fastener, etc., collectively referred to as hooks 21H, at the distal end thereof. If desired the cable 21 may have a spreader at the distal end thereof for stability in the transverse direction and minimizing undue transverse undulations. One of skill will recognize the cable 21 path will likely have the pulleys, brackets, guides, replaceable wear plates, etc. to assist in smooth extension and retraction of the cable 21, reduce wear and minimize friction, such hardware being omitted from the figures for clarity.

The deck 11 has one or more ports 10P therethrough. The ports 10P may be parallel to the vertical axis VA or skewed relative thereto. The ports 10P provide a path for the cable 21 from the winch 20 underneath the deck 11 to the pallet 70 on top of the deck 11

The cable 21 of a winch 20 may be extended from the winch 20 housing to be removably attached to a predetermined pallet. This pallet 70 may be disposed on the ground, the offload ramp of a cargo aircraft, on or elsewhere. The winch 20 retracts the cable 21 drawing the pallet 70 onto the ramp of the flatbed 10, then onto the deck 11. Once the pallet 70 is in position on the deck 11 the cable 21 is released from the pallet. The pallet 70 may then optionally be secured in position with tiedowns, etc. After the pallet 70 is offloaded at a point of use, the flatbed 10 is returned to pick up the next pallet.

For all embodiments described herein, the plural winches 20 may be mutually identical or may be mutually different. Mutually identical winches 20 provide the benefit of simplicity of manufacture and uniform maintenance procedures. Mutually different winches 20 provide the benefit of customization, so that a particular winch 20 may be selected for the intended missions without undue cost or weight. If three or more winches 20 are used, all winches 20 may be mutually identical, mutually different or a combination thereof. The winch 20 may have a load rating of 10,00 to 25,000 pounds at 15 to 20 feet per minute and a duty cycle of at least 75% percent. A HEN2500 winch 20 available from Novawinch of New York, NY has been found suitable.

The flatbed 10 may have at least one hydraulic power unit (HPU 22). The HPU 22 performs the function of withdrawing the ramp 30 into the deck 11 and extending the ramp 30 so that it protrudes outwardly from the deck 11. Each ramp 30 may have a dedicated HPU 22. Alternatively, a single HPU 22 may control two or more ramps 30.

The HPU 22 may be double acting and have a capacity of 1 to 5 gallons with a pressure of 1100 psi to 2300 psi. The HPU 22 preferably has an engine with at least 20 HP and preferably at least 22 HP. A Chief model GFGX16F3.2NVS05O-23 HPU 22 available from Bailey International, LLC of Knoxville, TN has been found suitable.

The flatbed 10 may be powered for locomotion by a gasoline engine 54, diesel engine 54, electric motor or a hybrid thereof, collectively referred to herein as an engine 54. A single engine 54 may be used, one engine 54 may be used for each of the front wheels 55 and the rear wheels 55 or each wheel 55 may have a dedicated engine 54.

The engine 54 may be operably connected to the wheel(s) in known fashion by a transmission. The flatbed 10 may be driven by an onboard driver 90, a remote driver 90, be preprogrammed to follow one or more routes or a combination thereof.

Referring to FIGS. 1E-1F, if desired the winches 20 may be transversely offset. One such winch 20 may be coincident the longitudinal axis LA and the other transversely offset from the longitudinal axis LA. Alternatively, both winches 20 may be transversely offset from the longitudinal axis LA, with for example, both winches 20 straddling the longitudinal axis LA or, alternatively both winches 20 on the same side thereof. This arrangement provides the benefit that the cables 21 of the respective winches 20 do not adversely overlap or interfere with each other, thereby inhibiting retraction or extension.

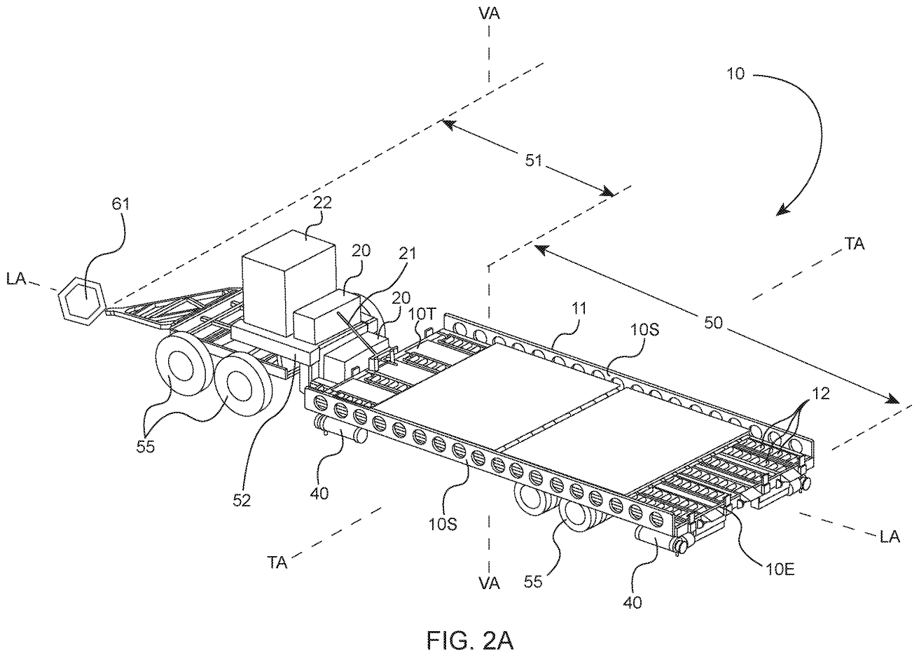

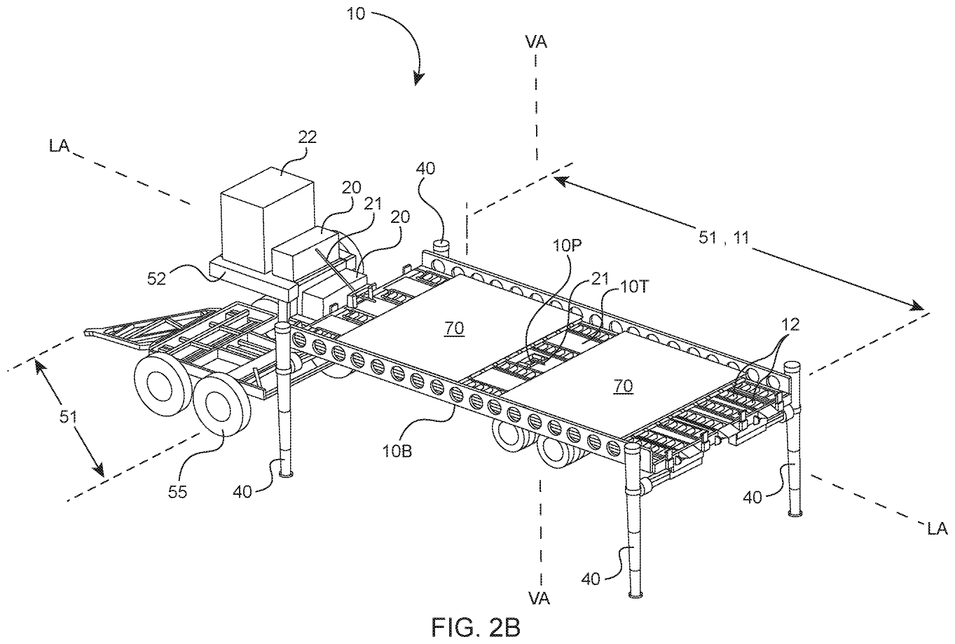

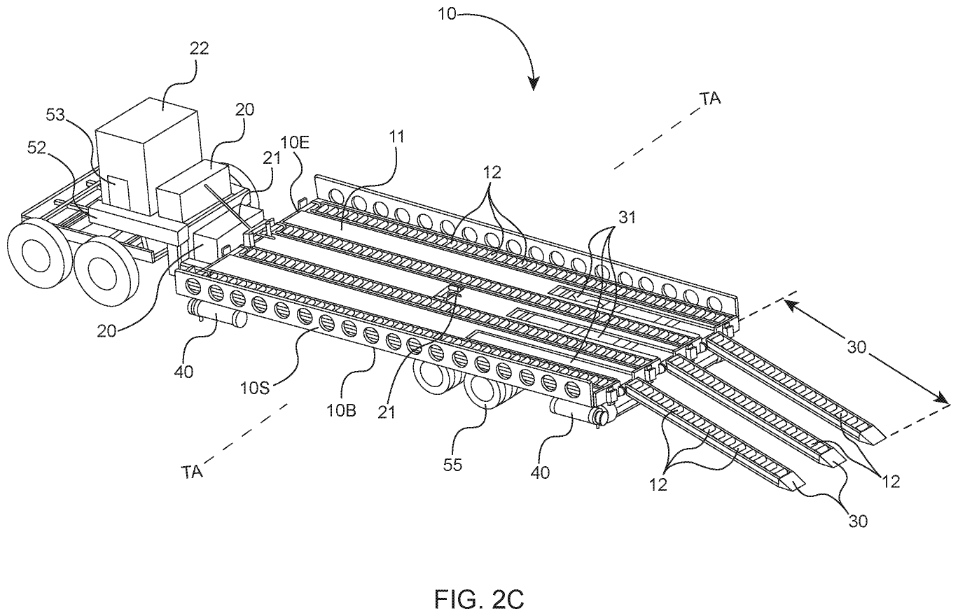

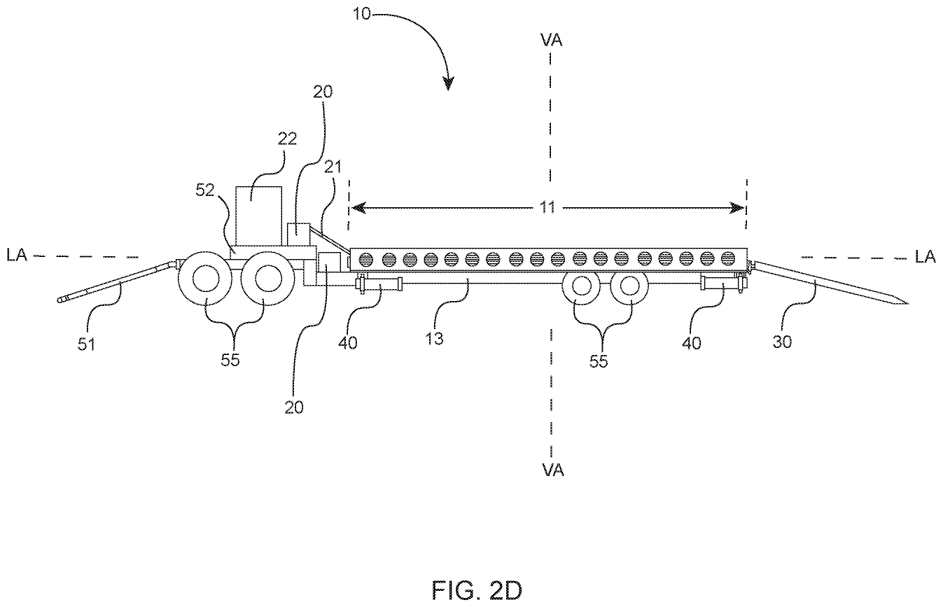

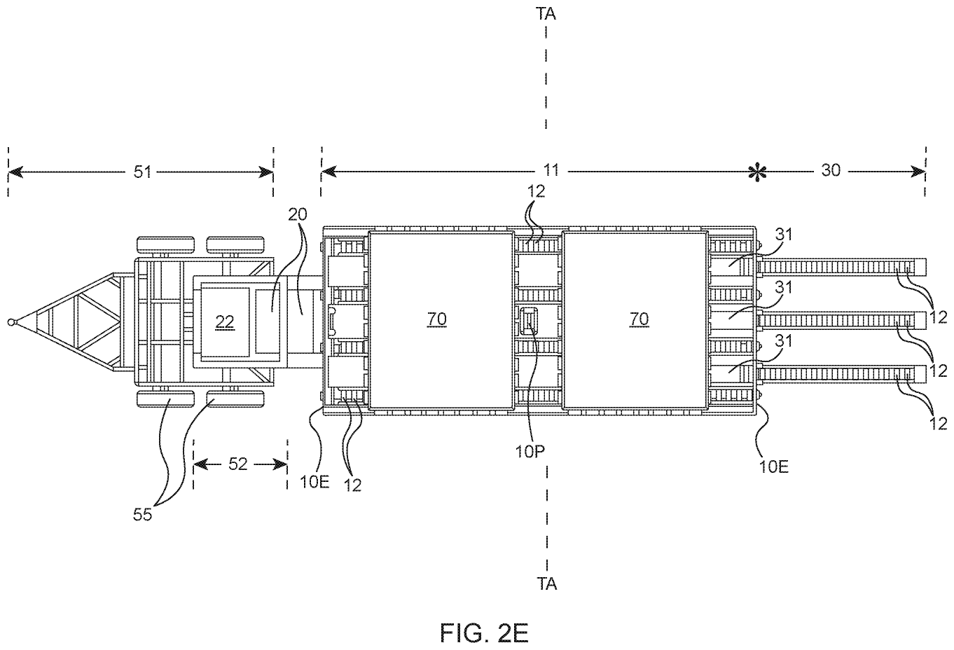

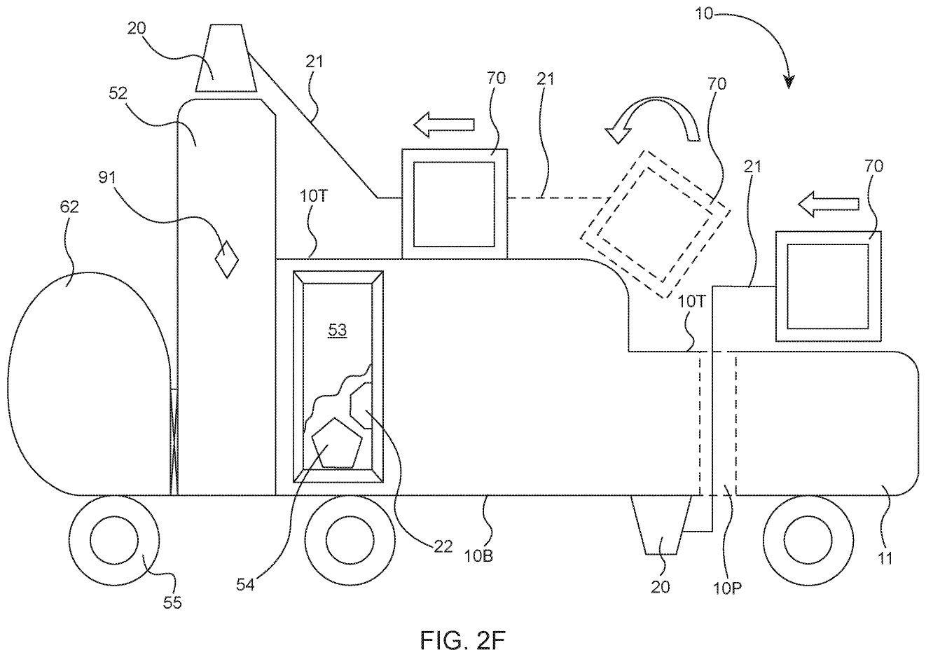

Referring to FIGS. 2A-2B, if desired, the flatbed 10 may be executed as a trailer 50 to be pulled by a tractor 61 and removably coupled thereto by a hitch 51. The forward winch 20 may be mounted on a perch 52 above the elevation of deck 11. The aft winch 20 can be mounted rearwardly of and below the forward winch. This arrangement provides the benefit that ground clearance is increased by not having critical components below the deck 11 and both winches 20 can be proximate the HPU 22, simplifying maintenance and conserving connections.

Similar to the previous embodiment, one which has a cable 21 path below the deck 11 of the flatbed 10. Particularly, the rearward winch 20 may be disposed so that the respective cable 21 is in line with the underside 10B of the deck 11, reducing friction through fewer turns and bends in the cable 21 path.

At the offload point for the cargo plane where the pallets 70 are loaded onto the deck 11 and/or at the point of use where the pallets 70 are offloaded from the deck 11, the flatbed 10 may deploy jacks 40 for stability. The jacks 40 may be telescoping and manually crank actuated to intercept the ground and, optionally level the deck 11. The stability provides the benefit of safety, minimizing the risk a pallet 70 could fall off of the deck 11 and injure personnel.

Referring to FIGS. 2C-2E, the ramps 30 may be extended to close the gap between the lowered end of the deck 11 and the ground. The ramps 30 may be pulled out of the tunnel 31 as far as reasonably needed to intercept the ground and thereby allow for smooth and continuous loading and unloading of the pallets 70 to/from the ramps 30 and ultimately to/from the deck 11 or ground.

Referring to FIG. 2F, if desired the flatbed 10 may be executed as a straight axle vehicle as shown. The straight axle execution of the flatbed 10 may have a forward cab 62, as shown, a rearward cab 62 or a longitudinally central cab 62.

The deck 11 may be stepped so that the pallets 70 disposed thereon may be disposed at two different elevations. The winch 20 for the upper step of the deck 11 may be disposed thereon or disposed on a separate perch 52 as shown.

This embodiment provides the benefit that the step(s) compensate for shorter and taller pallets 70 disposed on different levels of the deck 11. Furthermore, this embodiment provides the benefit that the elevated portion of the deck 11 may house the engine 54, winch, controls and other components inside the deck 11. These components may be accessed by a door 53 in the deck 11. This arrangement provides the benefit that these components are kept out of inclement weather and/or protected from hostile acts.

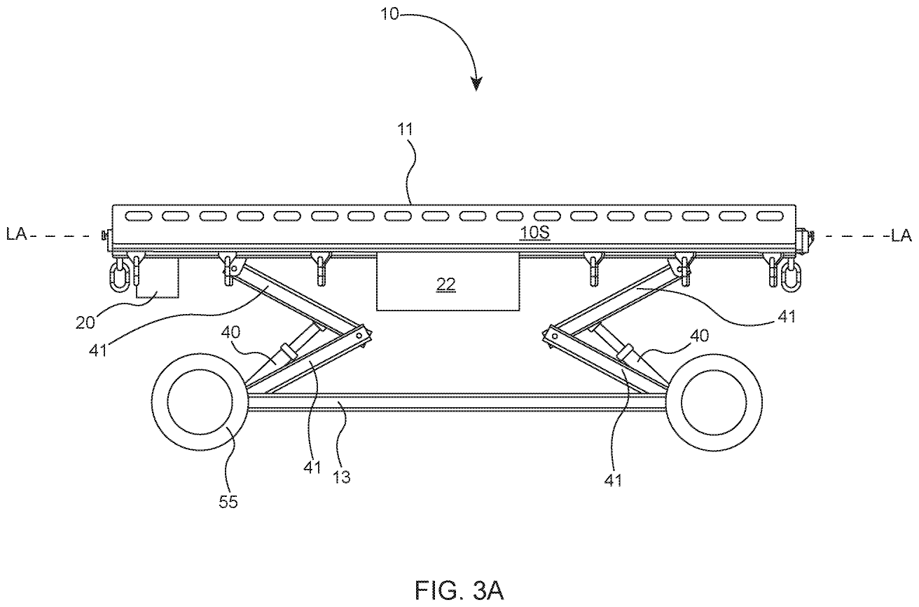

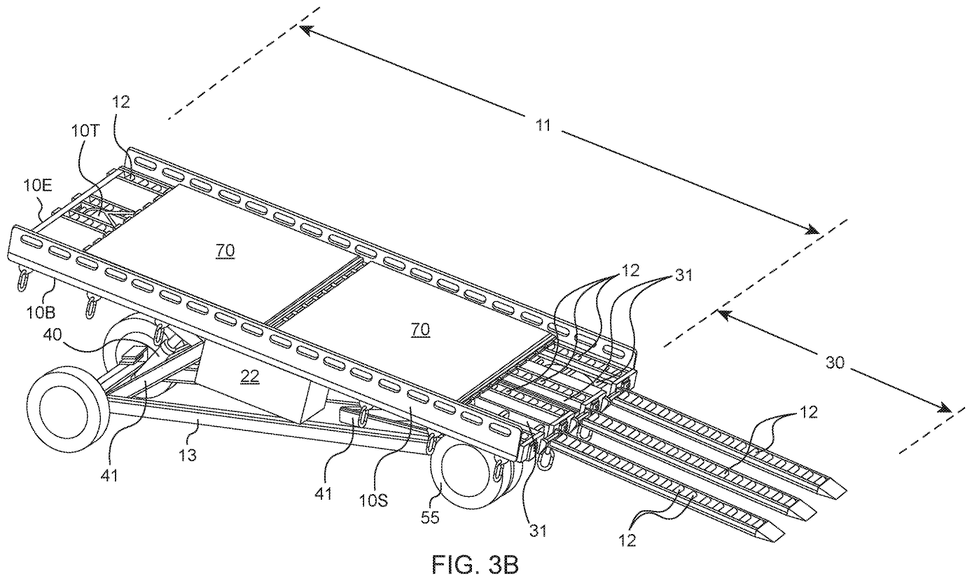

Referring to FIG. 3A, if desired the flatbed 10 may have one or more jacks 40 configured to rase and lower the deck 11 relative to the wheels 55 of the flatbed 10 and ground. The deck 11 may be raised and/or lowered in a disposition parallel to the ground. This arrangement provides the benefit of raising and lowering the pallets 70 for ergonomics and transport. For example, the deck 11, and any pallets 70 thereon may be lowered for loading and unloading or for clearance relative to overhead obstructions during transport. The deck 11 may be raised for ergonomics when inspecting the pallets 70 or removing cargo therefrom.

Any suitable jack 40 may be used, including hydraulic jacks 40 with a scissors mechanism 41, telescoping jacks 40, or a vertically oriented rack and pinion gear system. Alternatively, the jacks 40 may be scissors jacks 40, farm jacks 40 or a combination of any of the foregoing. The hydraulic jack 40 is preferably actuated from the HPU 22 or may be actuated from a separate motor. The jacks 40 may have a stroke length of 24 to 72 inches and a load capacity of at least 85,000 pounds. This arrangement provides for the deck 11 to raise and lower at least 30 inches and preferably at least 37 inches. A Heavy-Duty Hydraulic Stabilization Leg jack 40 available from Power-Packer of Oldenzaal, The Netherlands has been found suitable.

Referring to FIG. 3B, if desired, one end 10E of the deck 11 may be raised or lowered relative to the other end 10E of the deck 11. This arrangement provides the benefit that a pallet 70 may be readily loaded onto the deck 11 from the ground, as may occur at the tarmac when dispatched from the cargo aircraft. After the pallets 70 are loaded onto the deck 11 it may be leveled to be parallel to the ground, minimizing unintended displacement during transport to the points of use. This arrangement provides the benefit of requiring less manpower for initial loading of the pallets 70 without sacrificing safe transport with the pallets 70.

Or while one end 10E of the deck 11 is lowered towards the ground, the pallets 70 may be readily offloaded from the deck 11 onto the ground, as may occur at the points of use. The deck 11 may then be leveled for transport to the next point of use or return to the tarmac. This arrangement provides the benefit that damage to pallets 70 is minimized during unloading without sacrificing safe transport with the pallets 70 prior to unloading.

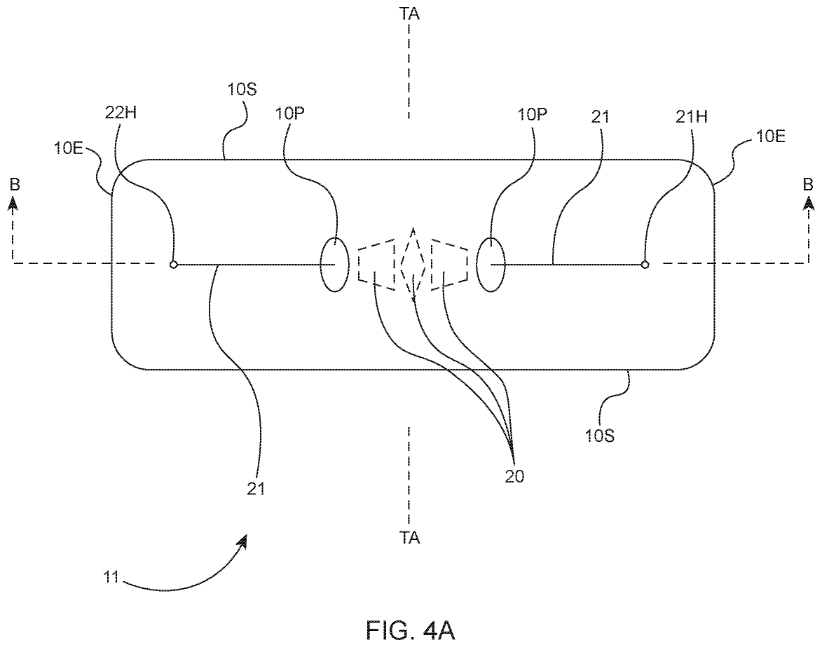

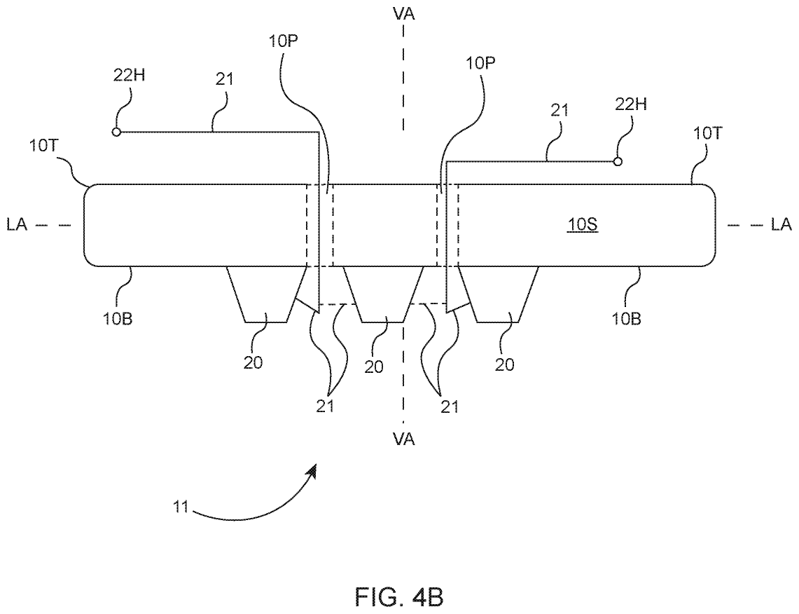

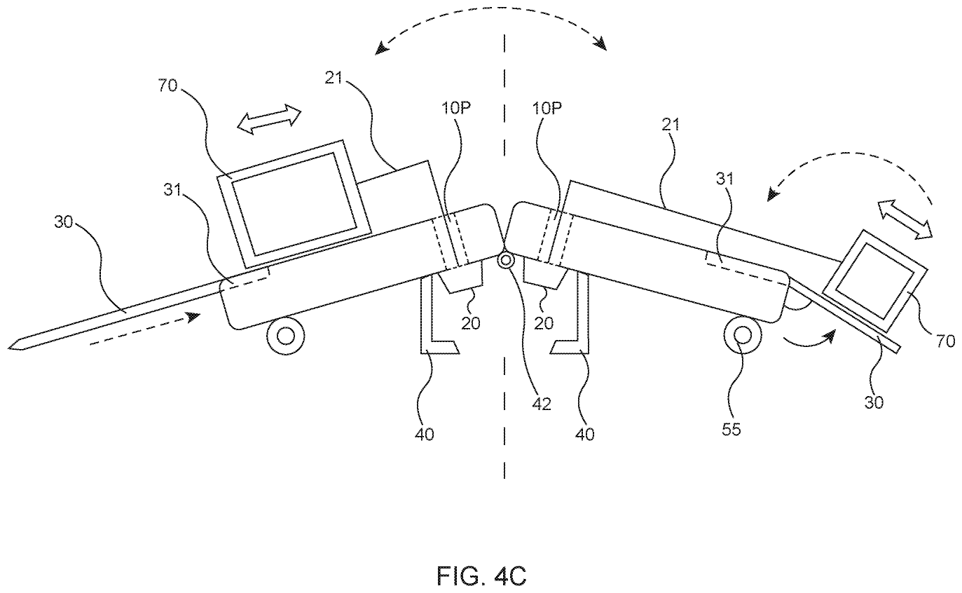

Referring to FIGS. 4A-4B, if desired each end 10E of the flatbed 10 may have a dedicated winch 20 therefor. Such winches 20 may be longitudinally spaced apart to be proximate a respective port 10Pand removably attachable to a corresponding pallet 70 for loading and unloading. This flatbed 10 has the capacity for uninterrupted and simultaneous loading and unloading of the pallets 70 without interference between the cables 21 of different winches 20. This arrangement provides the benefit that two pallets 70 may be simultaneously load, simultaneously offloaded or one pallet 70 may be loaded while a longitudinally spaced pallet 70 is simultaneously unloaded. The time for pallet 70 handling is reduced, conserving valuable resources in an austere environment.

If desired, a third and optional winch 20 may be provided. The third winch 20 may be interposed between the fore and aft winches 20 to provide longitudinally bilateral assist to either of the other winches 20 as needed.

Referring to FIG. 4C, if desired a hybrid flatbed 10 may be used. This hybrid flatbed 10 has the jacks 40 to raise or lower one end 10E of the deck 11. However the jacks 40 are juxtaposed with the transverse axis TA in this embodiment. The deck 11 may be centrally split and articulate about a hinge 42 responsive to the jacks 40 being extended in the vertical direction. Such extension causes the deck 11 to be raised in two halves, proximate the transverse axis TA. The ends 10E of the deck 11 articulate downwardly about the wheels 55 approaching the ground to facilitate loading and unloading of the pallets 70 as described above. Again one end 10E or both ends 10E of the flatbed 10 may have a ramp to bridge the gap from the end 10E of the deck 11 to the ground.

This arrangement provides the benefit of simultaneous loading and/or unloading of the pallets 70 as described above. This arrangement provides the further benefit of allowing controlled descent of the pallet 70 during unloading. This arrangement provides the further benefit of a smoother transition between the end 10E of the deck 11 and the ramp during loading and unloading.

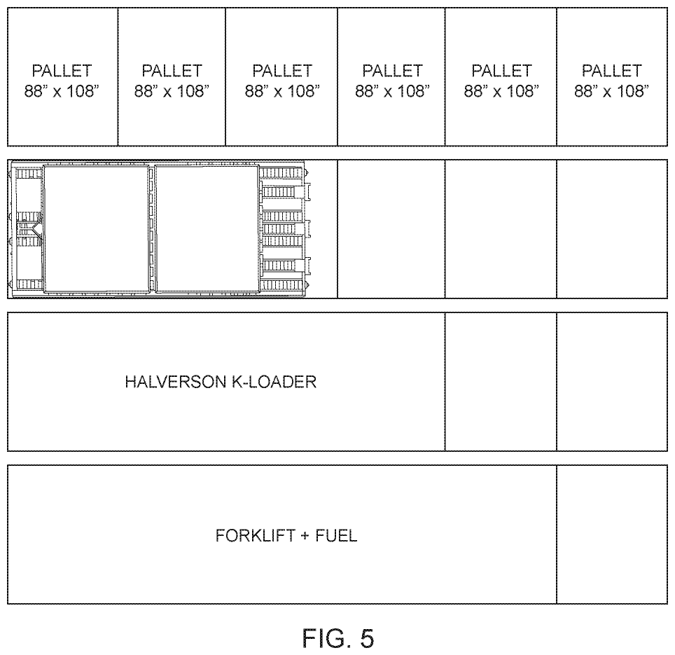

Referring to FIG. 5, the benefits of the claimed invention go beyond immediate loading and unloading in austere environments. On a cargo aircraft the present invention saves more than one pallet 70 position compared to a K-loader and saves more than two pallet 70 positions compared to a forklift. These pallet 70 positions can advantageously be used to transport more pallets 70 of equipment, supplies and other cargo, which pallets 70 are subsequently advantageously transported using the flatbed 10 of the present invention.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A flatbed for receiving and discharging plural pallets, the flatbed having a longitudinal axis and a transverse axis orthogonal thereto, the flatbed comprising:
a deck having a downwardly facing surface and a low friction upwardly facing surface opposed thereto, the deck having first and second longitudinally opposed ends; and
a first plurality of longitudinally spaced apart winches connected to the downwardly facing surface, each winch of the first plurality of winches having a retractable and extendible cable operably associated therewith,
whereby each cable is extendable from the corresponding winch below the flatbed to a respective port through the flatbed, upwards through the port and longitudinally above the flatbed to an edge of the flatbed for releasably attaching the cable to respective cargo.

2. The flatbed according to claim 1 having a first winch with a first port juxtaposed therewith defining a first cable path and a second winch having a second port juxtaposed therewith defining a second cable path, the first cable path and the second cable path being longitudinally spaced apart and disposed on the longitudinal axis.

3. The flatbed according to claim 2 wherein the first cable and the second cable longitudinally extend and retract in the same direction.

4. The flatbed according to claim 2 wherein the first cable and the second cable longitudinally extend and retract in opposite directions.

5. The flatbed according to claim 2 wherein both the first winch and the second winch are proximate the same end of the flatbed.

6. The flatbed according to claim 5 wherein the first cable path and the second cable path are transversely offset.

7. A flatbed for receiving and discharging plural pallets, the flatbed having a longitudinal axis and a transverse axis orthogonal thereto, the flatbed comprising:
a deck having a downwardly facing surface and a low friction upwardly facing surface opposed thereto, the deck having a front end and rear end longitudinally opposed thereto;
a first winch connected to the downwardly facing surface, the first winch having a retractable and extendible first cable operably associated therewith a port through the flatbed whereby the first cable is extendible through the port to be removably attachable to a first pallet disposed on the upwardly facing surface; and
a second winch forward of the first winch and juxtaposed with the upwardly facing surface, the second winch having a retractable and extendible second cable operably associated therewith and being removably attached to a second pallet disposed on the upwardly facing surface.

8. The flatbed according to claim 7 wherein the first winch and the second winch are configured to simultaneously load a first pallet and a second pallet, respectively to by simultaneously retracting the first cable and the second cable.

9. The flatbed according to claim 8 wherein the second winch is disposed on a perch adjacent the deck.

10. The flatbed according to claim 9 configured to be a trailer hitchable to a tractor for towing the trailer and the perch is a trailer hitch.

11. The flatbed according to claim 10 further comprising at least two leveling jacks for selectively raising the flatbed to a desired orientation.

12. The flatbed according to claim 11 further comprising at least one elongate ramp juxtaposed with a predetermined end and being extendible outwardly from the predetermined end, the at least one ramp having a ramp proximal end connected to the predetermined end of the flatbed and a ramp distal end remote therefrom and intercepting the ground upon projecting outwardly from the deck.

13. The flatbed according to claim 12 wherein the at least ramp proximal end is pivotally attached to the deck, so that the ramp distal end can intercept the ground without articulation of the deck.

14. The flatbed according to claim 12 wherein the deck of the flatbed is articulable so that the at least one ramp projecting outwardly from the predetermined end intercepts the ground, the deck and the at least one ramp forming a rectilinear loading surface.

15. The flatbed according to claim 8 in combination with a cab thereby forming a straight axle truck.

16. The flatbed according to claim 8 further comprising plural longitudinally oriented rows of axially rotatable rollers defining the upwardly facing surface and adapted to bilaterally longitudinally convey pallets on the deck.

17. A flatbed for receiving and discharging plural pallets, the flatbed having a longitudinal axis and a transverse axis orthogonal thereto, the flatbed comprising:
a deck having a downwardly facing surface and a low friction upwardly facing surface opposed thereto, the deck having a front end and rear end longitudinally opposed thereto;
a first winch connected to the downwardly facing surface, the first winch having a retractable and extendible first cable operably associated therewith, a first port through the flatbed whereby the first cable is extendible through the first port to be removably attachable to a first pallet disposed on the upwardly facing surface; and
a second winch longitudinally opposed to the first winch and connected to the downwardly facing surface, the second winch having a retractable and extendible second cable operably associated therewith, a second port through the flatbed and longitudinally spaced from the first port, whereby the second cable is extendible through the second port to be removably attachable to a second pallet disposed on the upwardly facing surface.

18. The flatbed according to claim 17 wherein the first winch and the second winch are operable to simultaneously load a first pallet onto a first end of the deck and to load a second pallet onto a second end of the deck.

19. The flatbed according to claim 18 further comprising a third winch connected to the downwardly facing surface intermediate the first winch and the second winch, the third winch having a retractable and extendible third cable operably associated therewith, the third winch being adapted to assist the first winch or the second winch to load a respective pallet onto the deck by extending the third cable though the correspond first port or second port for attachment to the respective pallet.

20. The flatbed according to claim 18 wherein the deck is split to simultaneously drop the first end and the second end for simultaneously loading and unloading of the first pallet and the second pallet onto pr from the deck, respectively.
